(19) United States
(12) Patent Application Publication
(10) Pub. No.: US 2005/0165903 A1
(43) Pub. Date: Jul. 28, 2005

(54) System and method for time based home page selection

(75) Inventors: Christopher Hoang Doan, Austin, TX (US); Liliana Orozco, Del Valle, TX (US); Leonel Saenz III, Austin, TX (US)

Correspondence Address: IBM CORPORATION- AUSTIN (JVL);C/O VAN LEEUWEN & VAN LEEUWEN, PO BOX 90609, AUSTIN, TX, 78709-0609, US

(73) Assignee: International Business Machines Corporation, Armonk, NY (US)

(21) Appl. No.: 10/765,779

(22) Filed: Jan. 27, 2004

(51) Int. Cl. G06F 15/16

(52) U.S. Cl. 709/217; 709/229

(57) ABSTRACT

A system and method is provided for selecting a home page for a browser based upon the time of day and day of week. In addition, a system and method is provided for selecting the home page based upon the network to which the user is connected. In one embodiment, the home page data is stored on nonvolatile storage accessible from the client's computer system and retrieved from such nonvolatile storage. In another embodiment, each of the client's computer systems has a home page identifier directed to a home page redirector web site. The home page redirector web site receives identification data from the client. The home page redirector retrieves home page web data corresponding to the client's preferences from its nonvolatile storage area, and redirects the client computer system to a different home page address based upon the time of day and/or client network connection data.

### BACKGROUND OF THE INVENTION

1. Technical Field

The present invention relates in general to a system and method for selecting a home, or start, page for a browser application. More particularly, the present invention relates to a system and method for selecting the home page based upon time data and network characteristics.

2. Description of the Related Art

Computer systems in general and International Business Machines (IBM) compatible personal computer systems in particular have attained widespread use for providing computer power to many segments of today's modern society. A personal computer system can usually be defined as a desk top, floor standing, or portable microcomputer that includes a system unit having a system processor and associated volatile and non-volatile memory, a display monitor, a keyboard, one or more diskette drives, a fixed disk storage device and an optional printer. One of the distinguishing characteristics of these systems is the use of a system board to electrically connect these components together. These personal computer systems are information handling systems which are designed primarily to give independent computing power to a single user (or a relatively small group of users in the case of personal computers which serve as computer server systems) and are inexpensively priced for purchase by individuals or small businesses. A personal computer system may also include one or a plurality of I/O devices (i.e. peripheral devices) which are coupled to the system processor and which perform specialized functions. Examples of I/O devices include modems, sound and video devices or specialized communication devices. Nonvolatile storage devices such as hard disks, CD-ROM drives and magneto-optical drives are also considered to be peripheral devices.

Computers are often linked to one another using a network, such as a local area network (LAN), wide area network (WAN), or other types of networks such as the Internet. By linking computers, one computer can use resources owned by another computer system. These resources can include files stored on nonvolatile storage devices and resources such as printers. An application program called a “browser” is used to view pages of information received from servers on a large computer network, such as the Internet.

Information displayed in the browser is provided by various web sites, or servers, which are often located far from the client computer system. This information provided by the servers generally includes text, graphics, sound, video files and other data. The information is organized into electronic document files called web pages. Web pages may contain hypertext links written in a software language such as the Hypertext Mark-up Language (HTML). Web browsers access these web pages at web sites via a communications protocol known as hypertext transport protocol (HTTP), which is a low-overhead protocol that capitalizes on the fact that navigation documents can be embedded directly. Web browsers are software interfaces that run on world wide web clients to allow access to web sites via a simple user interface. A web browser allows a web client to request a particular web page by specifying a Uniform Resource Locator (URL). A URL is a web address that identifies the web page and its location on the web. A user navigates through the network by selecting a hyperlink, or label, displayed in the browser, and the browser then loads the corresponding URL and downloads the web page or other associated data from the server.

Most browser programs include a “home page” icon that, when selected, directs the user to a predefined home page. While a user might be interested in different types of information throughout the day, changing the home page setting to a different URL is often a manual and somewhat tedious process. As a result, use a single home page throughout each day and on each day of the week. In addition, the user may be interested in work related information when connected to the user's office network and different information when connected to the user's home network. This is especially true when using a portable computing device, such as a laptop computer, at both work and at home.

A challenge to traditional home page implementations is, as described above, that a single home page does not often address the user's primary interest at any given point in time or on any given week. If the user sets his home page to an entertainment web site, then the user must repeatedly change to a work-related web site when at work. Likewise, if the user sets his home page to his company's web page, he finds himself repeatedly changing to a non-work web site when the user is at home.

What is needed, therefore, is a system and method for changing the user's home page based upon the time of day and day of the week. Furthermore, what is needed is a system and method for changing the user's home page based upon the network (e.g., a home network or a work network) to which the user is connected.

### SUMMARY

It has been discovered that the aforementioned challenges are resolved using a system and method that allows a user to select more than one home page where each of the selected home pages are active under different conditions. The conditions that apply include the time of day, the day of the week, and the network to which the user's computing device is connected.

When the user identifies a Web page that he wishes to use as a,home page, the system retrieves the address of the Web site (the URL). The system also determines, based upon user input, whether the Web page is desired when the user is using the current network to which the computing device is connected, a different network, or when the user is connected to any network. Then the system gathers the days of the week during which the Web page will be used as a home page as well as the start and end times during which the Web page will be used. The address of the Web page, the network settings, and the day of week/time data are stored in a nonvolatile storage location for subsequent retrieval.

When the user starts the browser application, or when the user selects the “home page” icon requesting the home page, the system retrieves the user's home page selection data in order to determine which Web address should be used as a home page. A default home page can also be stored so that if none of the time based/network based home pages match the current time/network setting, then the default web page is used.

In an alternate embodiment, the user's time and network based home page selections are stored in a redirection web site with the home page in the user's browser set to the redirection web site. When the user opens the browser or requests the home page, a request is sent to the redirection web site that looks up the home page based upon the current time (at the user's system) and the user's current network connection and redirects the user to the time/network based home page. If the user has several computing devices and wishes each of the computing devices to use the same time/network based home pages, then the user simply has the home page address for the browser in each of the devices. Included in the home page request is a user identifier that is used to locate the user's home page selections.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a system diagram of a client computing device retrieving and using a time and network connection based home page;

FIG. 2 is a flowchart showing the steps taken to gather time and network connection based home page data from the user;

FIG. 3 is a flowchart showing steps taken by the home page selector to select a home page based upon the current time and network connection being used by the user;

FIG. 4 is a system diagram of a client computing device receiving a home page identifier from a redirection web site that retrieves the user's preferred home page based upon the current time and the network connection being used by the user;

FIG. 5 is a flowchart showing steps taken by both the client device and the redirection web site in retrieving the home page identifier for the client and redirecting the client's browser to the identified home page; and

FIG. 6 is a block diagram of a computing device capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

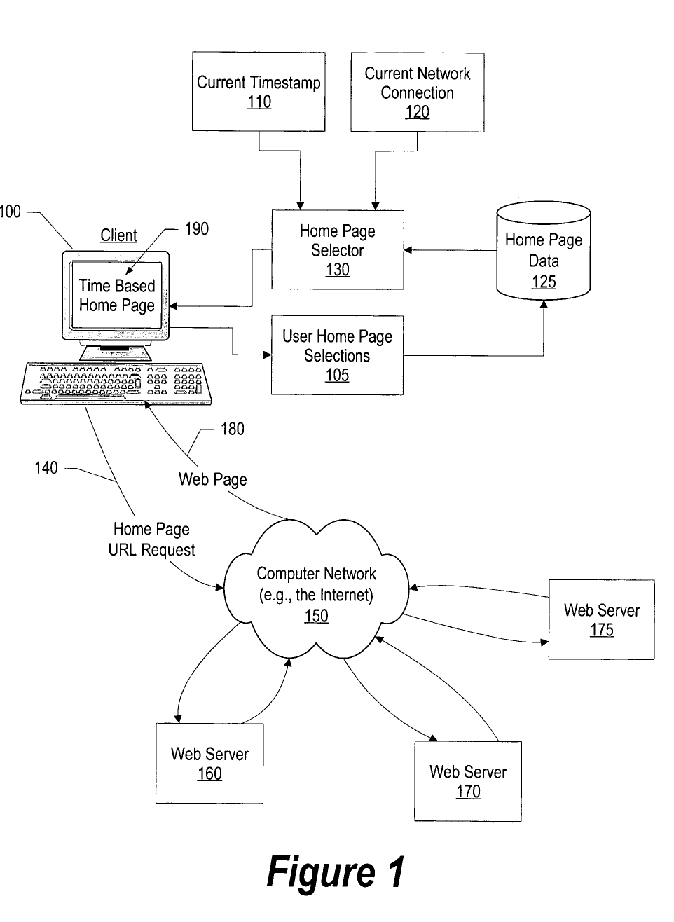

FIG. 1 is a system diagram of a client computing device retrieving and using a time and network connection based home page. Client computing device 100, such as a personal computer, personal digital assistant (PDA), or other device capable of running a browser to use the Internet, is connected to nonvolatile storage device 125, such as a hard drive.

The user of client computing device 100 makes home page selections (process 105) which are stored as home page data in nonvolatile storage device 125. When the user of client computing device 100 is surfing computer network 150 (i.e., the Internet), and identifies a Web page that he would like to use as a home page, process 125 is used to capture the URL of the Web page (either by the user making the home page request from the Web page, or by the user manually entering the name of the Web site, or the Web site's URL, in a data entry area. The user also indicates when the Web page should be used as the user's home page as well as the network connection, such as a home network or a work network, that should be currently active when the Web page is used as a home page. The time-based settings and network connection data are stored in home page data 125.

When the user, using the browser software, requests a home page (either by initializing the browser or by requesting the home page through a browser interface, such as an icon), home page selector process 130 retrieves the current timestamp (110) from the system clock running in computing device 100. The home pages selector process also retrieves the current network connection (120) that identifies the network to which client 100 is currently connected. Home page selector process 130 uses the current time data and the current network connection data to retrieve a Web page identifier (i.e., a URL) from home page data 125. The browser software running in client computing device 100 then uses the retrieved Web page identifier in making home page request 140 via computer network 150, such as the Internet.

In the example shown, there are three possible sources of home pages for client computing device 100 based upon the current time data and the current network connection data. These sources include Web Servers 160, 170, and 175. Home page request 140 will be directed to one of these Web Servers based upon the time and network connection data. Whichever web server hosts the Web page that is currently selected as the client's home page will receive request 140 and respond by sending Web page data 180 back to the client computing device over network 150. The client's time based home page (190) is then received at client computing device 100 and displayed on the computing device's display screen.

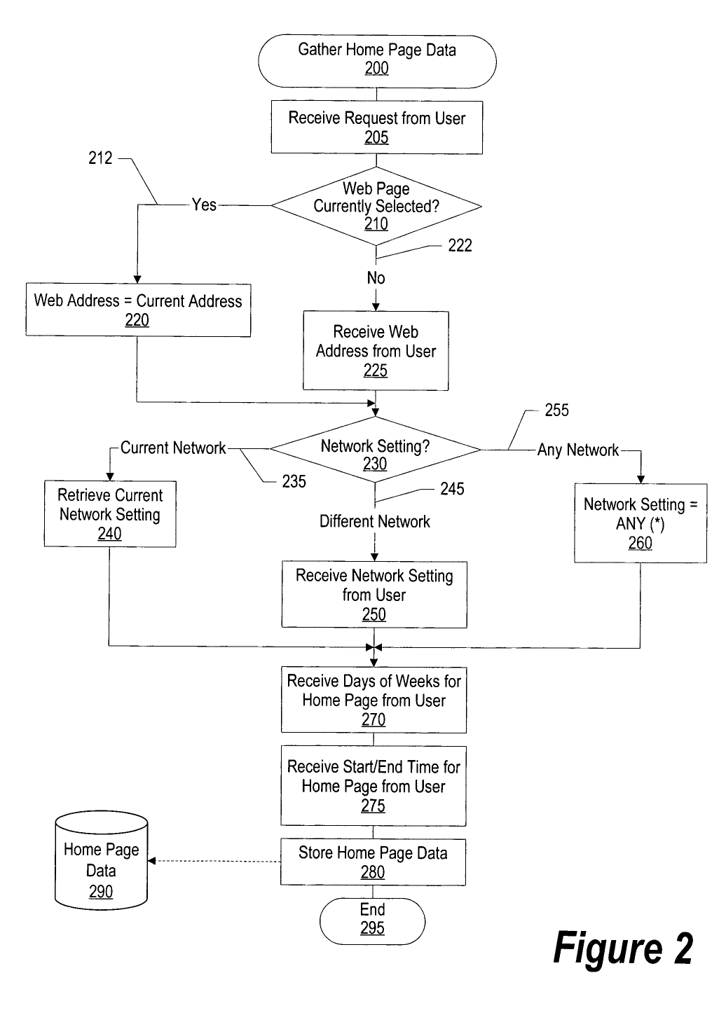

FIG. 2 is a flowchart showing the steps taken to gather time and network connection based home page data from the user. The steps shown in FIG. 2 are the detailed steps performed by the client computing device during process 105 shown in FIG. 1.

The flowchart in FIG. 2 commences at 200 whereupon, at step 205, a request to store a home page is received by a user of the computing device. A determination is made as to whether the user is requesting that a currently selected (i.e., displayed) Web page should be used as a home page. If the currently selected page is being requested for use as a home page, decision 210 branches to “yes” branch 212 whereupon, at step 220, the home page Web address is set to the address of the currently selected Web page. On the other hand, if the user wants a different, non-selected (i.e., non-displayed) Web page to be used as a home page, decision 210 branches to “no” branch 222 whereupon the user enters the home page Web address at step 225.

A determination is made as to the network setting that is desired before using the selected Web address as the user's home page address (decision 230). If the user wants the network to which the user's computing device is connected to be the one which is desired when using the selected Web address, then decision 230 branches to branch 235 whereupon, at step 240, the network setting (identifier) to which the computing device is connected is retrieved. If a different network is to be used other than the one to which the computing device is currently connected, then decision 230 branches to branch 245 whereupon, at step 245, the user provides the identifier for the network. In one embodiment, a list of networks used by the computing device is displayed to the user and the user selects from the list. If the Web page is to be used as a home page irregardless of the network to which the computing device is connected, then decision 230 branches to branch 255 whereupon, at step 260, an flag is set indicating that the Web page is used when “any” network is connected.

The user provides the days of the week for which the Web page will be used as a home page (step 270). For example, for a work-based home page, the user may decide to have the Web page be used as a home page during the week (Monday through Friday), but if the home page is a sports or recreation Web page, the user may decide to use it only on the weekends.

The user provides the starting and ending times that the Web page will be used as a home page (step 275). Using the example from above, for a work-based home page, the user may decide to have the Web page be used as a home page during working hours, such as 9:00 AM to 5:00 PM.

At step 280, the Web address that will be used as a home page along with the network connection criteria and day of the week and time data are stored in home page data store 290. When the user requests a home page, the data in home page data store 290 will be used to decide which Web page to use as the user's home page depending upon the current network connection, the current day of the week, and the current time of day information. Processing to gather the user's home page selections thereafter ends at 295.

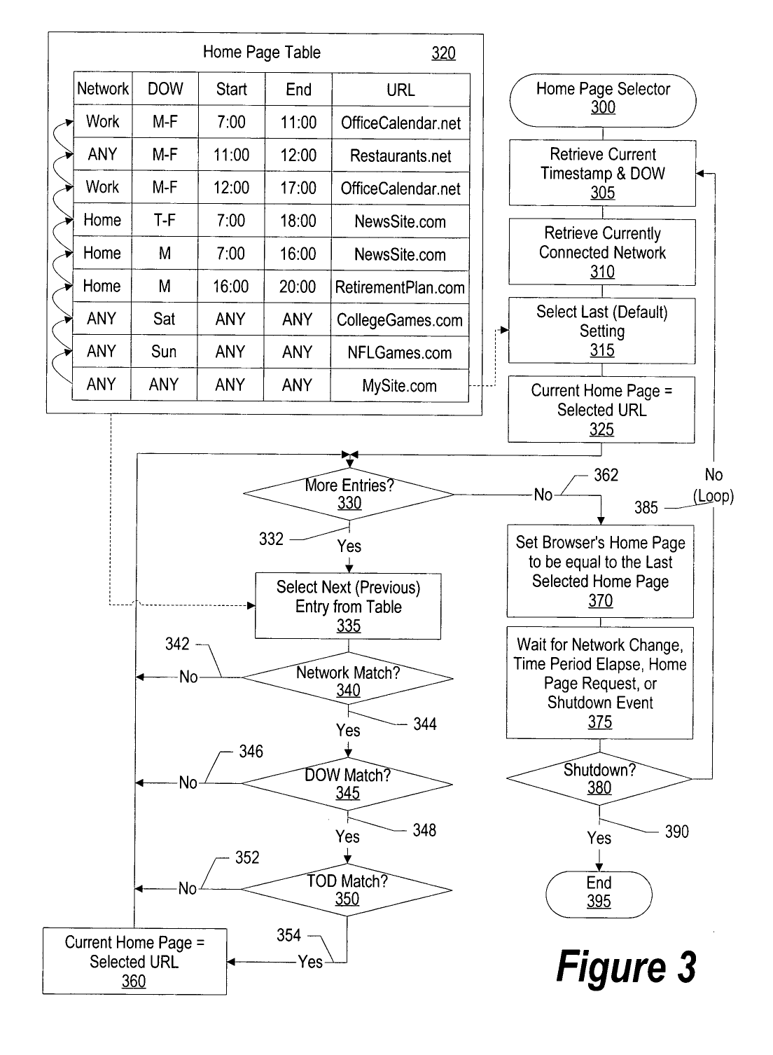

FIG. 3 is a flowchart showing steps taken by the home page selector to select a home page based upon the current time and network connection being used by the user. Processing commences at 300 whereupon, at step 305, the current timestamp and day of the week are retrieved from the clock included in the computing device. At step 310, the network identifier to which the computing device is currently connected is retrieved (i.e., from the Ethernet or other network interface adapter used to connect the computing device to a computer network).

At step 315, the last (i.e., default) entry in home page table 320 is retrieved. Home page table 320 is one embodiment for storing the home page data showed being stored in home page data 125 in FIG. 1 and 290 in FIG. 2. In the embodiment of home page table 320 shown in FIG. 3, home pages that correspond to more specific criteria are saved towards the top of the table and home pages with less specific criteria stored towards the bottom of the table. In the embodiment shown in table 320, the default, or first selected, home page is at the bottom of the list. As processing continues upward through the list, other the time and network criteria for other home pages are compared with the current time and the current network connection. If another home page matches the time and network criteria, that network is selected until either the end (top) of the list is reached or another home page closer to the top of the list matches the time and network criteria. In this manner, one home page is selected even though more than one home page may match the time and network criteria.

At step 325, the current best home page match is set to the most recently selected URL from table 310; in this case the default (bottommost) entry in table 310. A determination is made as to whether there are more entries to process in table 320 (decision 330). If there are more entries to process, decision 330 branches to “yes” branch 332 whereupon, at step 335, the next entry from the table is selected (i.e., the entry preceding the last selected entry)

A determination is made as to whether the newly selected entry has a network connection criteria that matches the device's current network connection (decision 340). If the network criteria does not match the device's current network connection, decision 340 branches to “no” branch 342 whereupon processing loops back to determine if there are more entries in the table to process. On the other hand, if the network criteria matches the device's current network connection, decision 340 branches to “yes” branch 344 to perform other comparisons.

A determination is made as to whether the day of the week criteria for the selected entry matches the current day of the week (decision 345). If the day of the week criteria does not match the current day of the week, decision 345 branches to “no” branch 346 whereupon processing loops back to determine if there are more entries in the table to process. On the other hand, if the day of the week criteria matches the current day of the week, decision 345 branches to “yes” branch 348 to perform other comparisons.

A determination is made as to whether the time of day range criteria for the selected entry matches the current time of day (decision 350). If the time of day range criteria does not match the time of day, decision 350 branches to “no” branch 352 whereupon processing loops back to determine if there are more entries in the table to process. On the other hand, if the time of day range criteria matches the current time of day, decision 350 branches to “yes” branch 354 whereupon the currently selected URL from table 320 is set to be the current home page (step 360). Processing then loops back to determine whether there are more entries in table 320 to process and, if there are more entries, these entries are evaluated to determine if they are better home pages, using the user's criteria, than the currently selected home page.

As will be appreciated by those skilled in the art, additional comparisons, such as day of the year, month, etc. can be included as additional criteria in table 320 to further define the home page desired by a user on a particular day, month, etc. For example, a person that celebrates Christmas could set a shopping site to be the home page when the date is between Thanksgiving and Christmas.

Returning to decision 330, when all entries in table 320 have been processed the best home page, given the user's criteria will have been selected, and decision 330 branches to “no” branch 362. At step 370, the browser's home page is set to be the last home page that was selected during steps 325 through 360. Now, when the user requests the home page, the time and network based home page will be requested. The processing shown in FIG. 3 is also performed when the browser is initialized so that the initial home page displayed on the browser is a time/network based home page.

At step 375, processing waits for an event to occur, such as a change in the device's network connection, an expiration of a time period (if the time/network based home page is refreshed on a particular time interval), another home page request is made by the user, or a shutdown event (shutting down the device), is made. A determination is made as to whether a system shutdown even has occurred (decision 380). If the event is not a system shutdown, decision 380 branches to “no” branch 385 whereupon processing loops back to select a time/network based home page. This looping continues until a shutdown event occurs, at which point decision 380 branches to “yes” branch 390 and processing ends at 395.

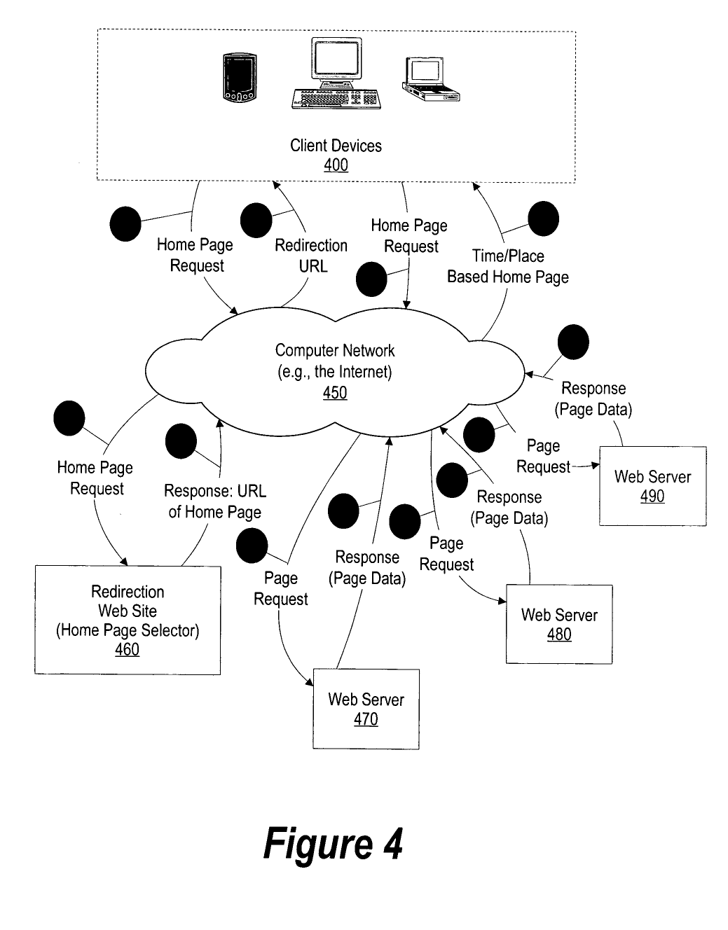

FIG. 4 is a system diagram of a client computing device receiving a home page identifier from a redirection web site that retrieves the user's preferred home page based upon the current time and the network connection being used by the user. This is a network implementation for gathering home page data and criteria (shown in FIG. 2) and selecting time/network based home pages using the gathered information (shown in FIG. 3).

Each of a user's devices (400), such as a personal digital assistant (PDA), desktop PC, and a laptop PC, are each provided the same redirection Web site as the home page in the browser used by each of the devices. When the user opens the browser or requests a home page from any device that has the redirection Web site as the home page, a home page request (1) is sent through computer network 450 (such as the Internet), and is received (2) at redirection web site 460. The redirection web site uses home page criteria, such as that shown in table 320 in FIG. 3, to determine the home page that the user desires given the current time, current day of the week, and current network connection used at the client device. In this manner, the user maintains the home page preferences at one location (the redirection web site) and simply sets the browser's home page of any device that he wishes to use the time/network based home pages to the redirection web site.

Redirection web site 460 searches a table containing the user's home page preferences (such as table 320 in FIG. 3), and responds (3) with the URL of the time/network based home page that is desired by the user given the current time of day, day of week, and network connection. The redirection URL travels through network 450 and is received (4) by the client device (400) that made the request. The browser of the client device is redirected to the new web page by sending a request (5) using the received redirection URL.

In the example shown, there are three possible sources of home pages for client computing devices 400 based upon the current time data and the current network connection data. These sources include Web Servers 470, 480, and 490. Home page request (5) is directed to one of these Web Servers based upon the time and network connection data. Whichever web server hosts the Web page that is currently selected as the client's home page will receive request (6) and respond by sending Web page data (7) back to the client computing device over network 450. The client's time/network based home page (8) is then received at client computing device 400 and displayed on the computing device's display screen.

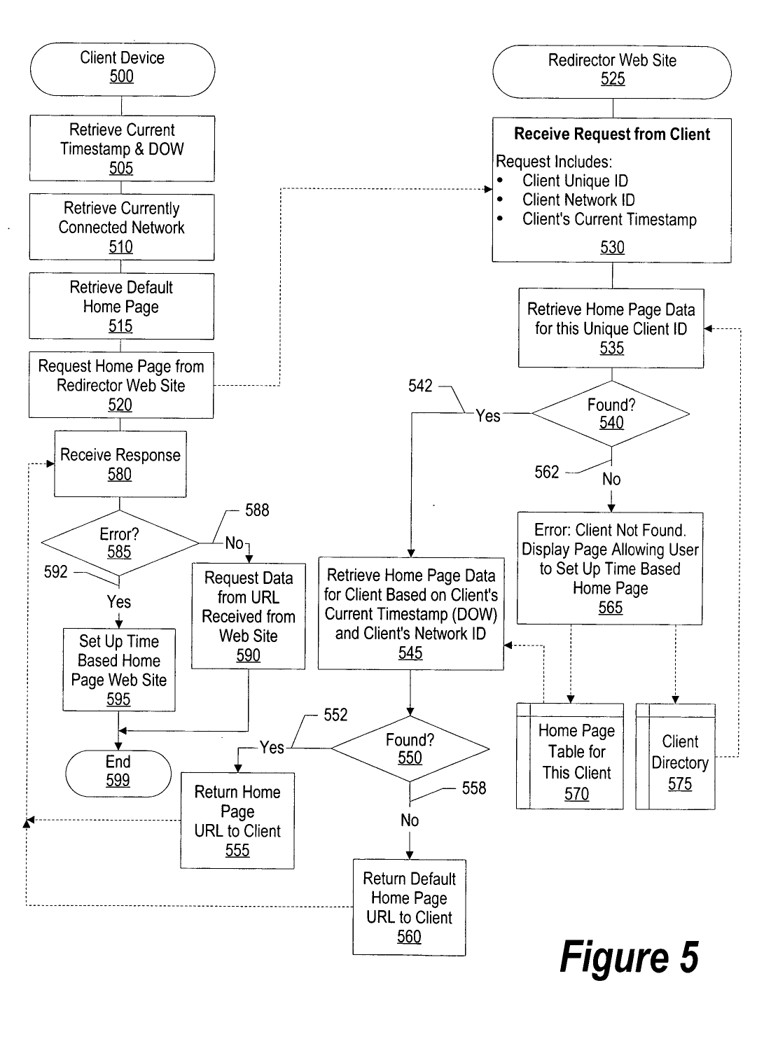

FIG. 5 is a flowchart showing steps taken by both the client device and the redirection web site in retrieving the home page identifier for the client and redirecting the client's browser to the identified home page. Client processing commences at 500 whereupon, at step 505, the current time is retrieved from the clock running in the client device and the current day of the week is computed based upon the date. At step 510, the network connection currently connecting the device to a computer network is retrieved. At step 515, the address of the default home page is retrieved. The default home page address is the address of the redirection web site. The time/network based home page is requested, at step 520, from the redirection web site.

Redirection web site processing commences at 525 whereupon, at step 530, a request is received from the client computing device. The request includes a user identifier, identifying the user, a client network identifier, identifying the client device's current network connection, and a timestamp providing data about the time of day and day of week information at the client computing device. In one embodiment, the request data, such as the user identifier, is stored on the client computing device as a “cookie” and retrieved by the redirection web site using standard cookie processing.

At step 535, the redirection web site retrieves the home page selections that correspond to the user identifier making the request from client directory 575. In one embodiment, client directory 575 and home page tables 570 are combined in one larger database that includes home page selections for any number of users. In another embodiment, client directory 575 is a directory of all active clients of the redirection web site while home page table 570 is a separate table for each of the clients.

A determination is made as to whether the user identifier for the user making the request was found in the client directory (decision 540). If the user identifier was found, decision 540 branches to “yes” branch 542 whereupon, at step 545, the redirection web site retrieves (from home page table 570) the best home page for the user based upon the user's current time and network connection setting (see FIG. 3 for details regarding how the home page is selected). For an example of home page table 570, see home page table 320 in FIG. 3. A determination is made as to whether a preferred home page was found for the user given the user's current time and network connection settings (decision 550). If a preferred home page was found, decision 550 branches to “yes” branch 552 whereupon, at step 555, the URL for the selected home page is returned to the user's device. On the other hand, if a preferred home page was not found, decision 550 branches to “no” branch 558 whereupon, at step 560, a default home page is returned to the user's device.

Returning to decision 540, if the user's identifier was not found in client directory 575, decision 540 branches to “no” branch 562 whereupon, at step 565, an error is returned to the client allowing the user to set up time/network based home page settings and this data is stored in home page table 570 and client directory 575. For a description of the gathering and storing of client home page preferences, see FIG. 2 and corresponding text.

Returning to client processing, the client receives a response from the redirection web site at step 580. A determination is made as to whether the response is an error (decision 585) indicating that the user does not have an account at the redirection web site. If the response was not an error (i.e., the response was a redirection URL to a web site to use as a home page), decision 585 branches to “yes” branch 588 whereupon, at step 590, the client computing device requests the web page corresponding to the URL received from the redirection web site. On the other hand, if the client received an error, decision 585 branches to “yes” branch 592 whereupon, at step 595, the user sets up an account with the redirection web site and stores time/connection based home page selections on the redirection web site (see FIG. 2 for further details regarding the gathering and storing of home page addresses and criteria). Client processing thereafter ends at 599.

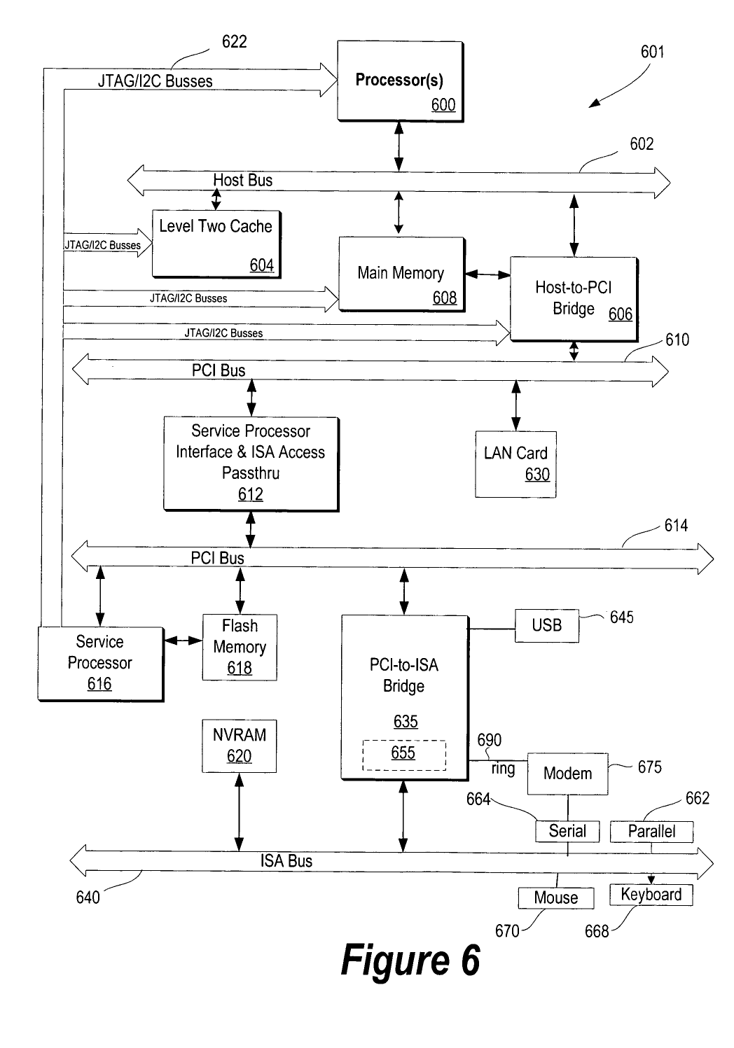

FIG. 6 illustrates information handling system 601 which is a simplified example of a computer system capable of performing the computing operations described herein. Computer system 601 includes processor 600 which is coupled to host bus 602. A level two (L2) cache memory 604 is also coupled to host bus 602. Host-to-PCI bridge 606 is coupled to main memory 608, includes cache memory and main memory control functions, and provides bus control to handle transfers among PCI bus 610, processor 600, L2 cache 604, main memory 608, and host bus 602. Main memory 608 is coupled to Host-to-PCI bridge 606 as well as host bus 602. Devices used solely by host processor(s) 600, such as LAN card 630, are coupled to PCI bus 610. Service Processor Interface and ISA Access Pass-through 612 provides an interface between PCI bus 610 and PCI bus 614. In this manner, PCI bus 614 is insulated from PCI bus 610. Devices, such as flash memory 618, are coupled to PCI bus 614. In one implementation, flash memory 618 includes BIOS code that incorporates the necessary processor executable code for a variety of low-level system functions and system boot functions.

PCI bus 614 provides an interface for a variety of devices that are shared by host processor(s) 600 and Service Processor 616 including, for example, flash memory 618. PCI-to-ISA bridge 635 provides bus control to handle transfers between PCI bus 614 and ISA bus 640, universal serial bus (USB) functionality 645, power management functionality 655, and can include other functional elements not shown, such as a real-time clock (RTC), DMA control, interrupt support, and system management bus support. Nonvolatile RAM 620 is attached to ISA Bus 640. Service Processor 616 includes JTAG and I2C busses 622 for communication with processor(s) 600 during initialization steps. JTAG/I2C busses 622 are also coupled to L2 cache 604, Host-to-PCI bridge 606, and main memory 608 providing a communications path between the processor, the Service Processor, the L2 cache, the Host-to-PCI bridge, and the main memory. Service Processor 616 also has access to system power resources for powering down information handling device 601.

Peripheral devices and input/output (I/O) devices can be attached to various interfaces (e.g., parallel interface 662, serial interface 664, keyboard interface 668, and mouse interface 670 coupled to ISA bus 640. Alternatively, many I/O devices can be accommodated by a super I/O controller (not shown) attached to ISA bus 640.

In order to attach computer system 601 to another computer system to copy files over a network, LAN card 630 is coupled to PCI bus 610. Similarly, to connect computer system 601 to an ISP to connect to the Internet using a telephone line connection, modem 675 is connected to serial port 664 and PCI-to-ISA Bridge 635.

While the computer system described in FIG. 6 is capable of executing the processes described herein, this computer system is simply one example of a computer system. Those skilled in the art will appreciate that many other computer system designs are capable of performing the processes described herein.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A computer implemented method comprising:
obtaining a timestamp identifying a current time and a current day;
retrieving, from a nonvolatile storage device, a home page identifier based upon the timestamp; and
setting a browser's home page to the retrieved home page identifier.

2. The computer implemented method of claim 1 further comprising:
obtaining a network connection identifier that identifies a computer network, wherein the retrieving of the home page identifier is based upon both the timestamp and the network connection identifier.

3. The computer implemented method of claim 1 further comprising:
receiving, over a computer network, at a redirection web site, a home page request from a client computing device, the home page request including a user identifier that identifies a user of the client device, wherein the redirection web site performs the obtaining, retrieving, and setting steps;
wherein the setting of the browser's home page includes redirecting the browser executing on the client computing device to the retrieved home page identifier.

4. The computer implemented method of claim 3 further comprising:
obtaining one or more network connection identifiers that identify one or more computer networks to which the client computing device is connected from the home page request, wherein the retrieving of the home page identifier is based upon both the timestamp and the network connection identifier.

5. The computer implemented method of claim 3 wherein the obtaining of the timestamp includes retrieving a current timestamp from the home page request, wherein the current timestamp corresponds to the current time and the current day at the client computing device.

6. The computer implemented method of claim 5 wherein the retrieval of the home page identifier further comprises:
selecting, from the nonvolatile storage device, one or more records that correspond to the user identifier, wherein the nonvolatile storage device includes records for a plurality of user identifiers; and
identifying, from the group of selected records, the home page identifier based upon the timestamp.

7. The computer implemented method of claim 6 further comprising:
obtaining one or more network connection identifiers that identify one or more computer networks to which the client computing device is connected from the home page request, wherein the identification of the home page identifier is based upon both the timestamp and the network connection identifier.

8. An information handling system comprising:
one or more processors;
a memory accessible by the processors;
a nonvolatile storage device;
one or more network adapters connecting the information handling system to one or more computer networks; and
an home page selection tool for selecting a home page, the home page selection tool including:
means for obtaining a timestamp identifying a current time and a current day;
means for retrieving, from the nonvolatile storage device, a home page identifier based upon the timestamp; and
means for setting a browser's home page to the retrieved home page identifier.

9. The information handling system of claim 8 further comprising:
means for obtaining a network connection identifier that identifies a computer network, wherein the retrieving of the home page identifier is based upon both the timestamp and the network connection identifier.

10. The information handling system of claim 8 wherein the information handling system is a redirection web site, the information handling system further comprising:
means for receiving, over one of the computer networks, from a client computing device, a home page request, the home page request including a user identifier that identifies a user of the client device, wherein the redirection web site performs the means for obtaining, the means for retrieving, and the means for setting;
wherein the means for setting the browser's home page includes means for redirecting the browser executing on the client computing device to the retrieved home page identifier.

11. The information handling system of claim 10 further comprising:
means for obtaining one or more network connection identifiers that identify one or more computer networks to which the client computing device is connected from the home page request, wherein the retrieving of the home page identifier is based upon both the timestamp and the network connection identifier.

12. The information handling system of claim 10 wherein the means for obtaining of the timestamp includes means for retrieving a current timestamp from the home page request, wherein the current timestamp corresponds to the current time and the current day at the client computing device.

13. The information handling system of claim 12 wherein the means for retrieving the home page identifier further comprises:
means for selecting, from the nonvolatile storage device, one or more records that correspond to the user identifier, wherein the nonvolatile storage device includes records for a plurality of user identifiers; and
means for identifying, from the group of selected records, the home page identifier based upon the timestamp.

14. A computer program product stored on a computer operable media comprising:
means for obtaining a timestamp identifying a current time and a current day;
means for retrieving, from a nonvolatile storage device, a home page identifier based upon the timestamp; and
means for setting a browser's home page to the retrieved home page identifier.

15. The computer program product of claim 14 further comprising:
means for obtaining a network connection identifier that identifies a computer network, wherein the means for retrieving the home page identifier is based upon both the timestamp and the network connection identifier.

16. The computer program product of claim 14 further comprising:
means for receiving, over a computer network, at a redirection web site, a home page request from a client computing device, the home page request including a user identifier that identifies a user of the client device, wherein the redirection web site performs the means for obtaining, the means for retrieving, and the means for setting;
wherein the means for setting the browser's home page includes means for redirecting the browser executing on the client computing device to the retrieved home page identifier.

17. The computer program product of claim 16 further comprising:
means for obtaining, from the home page request, one or more network connection identifiers that identify one or more computer networks to which the client computing device is connected, wherein the means for retrieving the home page identifier is based upon both the timestamp and the network connection identifier.

18. The computer program product of claim 16 wherein the means for obtaining the timestamp includes means for retrieving a current timestamp from the home page request, wherein the current timestamp corresponds to the current time and the current day at the client computing device.

19. The computer program product of claim 18 wherein the means for retrieving the home page identifier further comprises:
means for selecting, from the nonvolatile storage device, one or more records that correspond to the user identifier, wherein the nonvolatile storage device includes records for a plurality of user identifiers; and
means for identifying, from the group of selected records, the home page identifier based upon the timestamp.

20. The computer program product of claim 19 further comprising:
means for obtaining, from the home page request, one or more network connection identifiers that identify one or more computer networks to which the client computing device is connected, wherein the means for identifying the home page identifier is based upon both the timestamp and the network connection identifier.
